(19) United States
(12) Patent Application Publication
(10) Pub. No.: US 2016/0295361 A1
(43) Pub. Date: Oct. 6, 2016

(54) DYNAMIC COOPERATIVE GEOFENCE

(71) Applicant: AGCO CORPORATION, Hesston, KS (US)

(72) Inventor: Ryan Ardin Jelle, Hesston, KS (US)

(73) Assignee: AGCO Corporation, Hesston, KS (US)

(21) Appl. No.: 15/035,673

(22) PCT Filed: Nov. 25, 2014
(86) PCT No.: PCT/US14/67227

§ 371 Date: May 10, 2016

Related U.S. Application Data
(60) Provisional application No. 61/908,267, filed on Nov. 25, 2013.
(60) Provisional application No. 61/939,339, filed on Feb. 13, 2014.
(60) Provisional application No. 61/939,343, filed on Feb. 13, 2014.

(51) Int. Cl. H04W 4/02

(52) U.S. Cl. CPC H04W 4/021; H04W 4/022; H04W 4/02; H04W 4/023

(57) ABSTRACT

A system includes one or more location determining devices for determining the geographic locations of a plurality of mobile objects and one or more computing devices. The one or more computing devices are operable to identify the geographic locations of the objects using data generated by the one or more location determining devices, generate a single geofence corresponding to the geographic locations of the plurality of mobile objects, identify a change in the geographic location of at least one of the objects, change the geofence to reflect the change in the geographic location of the at least one object, detect an event associated with the geofence, and respond to the event.

### FIELD

Embodiments of the present invention relate to systems and methods of using geofences to monitor and manage the operation of mobile objects.

### BACKGROUND

It is often desirable to monitor or manage groups of mobile objects. In the agriculture industry, for example, fleets of mobile machines such as combine harvesters and tractors may be operating in the same field or area. In the construction industry, a fleet of machines such as scrapers, bulldozers and tractors may be operating in the same area. In these situations it may be desirable to monitor the location of all of the machines to assess progress, avoid hazardous situations, and so forth.

The above section provides background information related to the present disclosure which is not necessarily prior art.

### SUMMARY

A system in accordance with a first embodiment of the invention comprises one or more location determining devices for determining the geographic locations of a plurality of mobile objects and one or more computing devices. The one or more computing devices are operable to identify the geographic locations of the objects using data generated by the one or more location determining devices, generate a single geofence corresponding to the geographic locations of the plurality of mobile objects, identify a change in the geographic location of at least one of the objects, change the geofence to reflect the change in the geographic location of the at least one object, detect an event associated with the geofence, and respond to the event.

A non-transitory machine-readable storage medium according to another embodiment of the invention has instructions stored therein which, when executed by one or more computing devices, cause the one or more computing devices to perform operations. The operations comprise identifying the location of each of a plurality of mobile objects, generating a single geofence corresponding to the locations of the plurality of mobile objects, identifying a change in the location of at least one of the mobile objects, changing the geofence to reflect the change in the location of the at least one of the mobile objects, detecting an event associated with the geofence, and responding to the event.

A system in accordance with another embodiment of the invention comprises one or more location determining devices for determining the location of each of a plurality of mobile objects, and one or more computing devices. The one or more computing devices are operable to identify the location of each of the mobile objects using data generated by the one or more location determining devices and generate a single geofence corresponding to the plurality of mobile objects. The geofence is defined in a nodal region of each object according to nodal parameters associated with each object. The nodal parameters are indicated by a user and include a distance from each of the mobile objects and a shape. The geofence is further defined between the nodal regions by segment parameters associated with each segment between the nodal regions, the segment parameters being indicated by a user and including shape information.

The one or more computing devices are further operable to identify changes in the location of each of the mobile objects, change the geofence to reflect the changes in the locations of the mobile objects, the changed geofence being defined by the nodal parameters and the segment parameters, detect an event associated with the geofence, and respond to the event.

These and other important aspects of the present invention are described more fully in the detailed description below. The invention is not limited to the particular methods and systems described herein. Other embodiments may be used and/or changes to the described embodiments may be made without departing from the scope of the claims that follow the detailed description.

### DRAWINGS

Embodiments of the present invention are described in detail below with reference to the attached drawing figures, wherein:

FIG. 1 is a schematic diagram of exemplary computer and communications equipment that may be used to implement certain aspects of the present invention.

FIG. 2 is a schematic diagram of an exemplary machine communications and control system, various components of which may be used to implement certain aspects of the present invention.

FIG. 3 is a schematic diagram of a system in accordance with embodiments of the invention.

FIG. 4 is a flow diagram of various exemplary steps involved in a method of creating a geofence.

FIG. 5 is a graphical representation of various objects that may be associated with a geofence created in accordance with embodiments of the invention.

FIG. 6 is a graphical representation of the objects depicted in FIG. 5, including axes used in an exemplary method of selecting seed objects for use in creating an initial geofence.

FIG. 7 is a graphical representation of the objects depicted in FIG. 5, illustrating nodal boundaries associated with various objects selected as seed objects.

FIG. 8 is a graphical representation of the objects depicted in FIG. 5, illustrating connecting segments interconnecting the nodal boundaries.

FIG. 9 is a graphical representation of the objects depicted in FIG. 5, illustrating a geofence associated with a group of the objects and being defined by the nodal boundaries and the connecting segments illustrated in FIGS. 7-8.

FIG. 10 illustrates some exemplary variations in the size and shape of the nodal boundaries.

FIGS. 11A and 11B illustrate some exemplary variations in the connecting segments.

FIG. 12 illustrates the geofence depicted in FIG. 9, wherein one of the objects has moved to a different location and the shape of the geofence has changed to reflect the movement of the object.

FIG. 13 illustrates the geofence depicted in FIG. 9, wherein an object not initially associated with the geofence has moved to a location close enough to the geofence to be associated with the geofence.

FIG. 14 illustrates the geofence and objects depicted in FIG. 13, wherein the geofence has been modified to include the newly-included object.

FIG. 15 illustrates a geofence associated with a plurality of objects and proximate a geographic feature, wherein proximity to or intersection with the geographic feature may constitute an event associated with the geofence triggering a response.

FIG. 16 illustrates a geofence associated with a plurality of objects and proximate an external object, wherein proximity to or intersection with the object may constitute an event associated with the geofence triggering a response.

FIG. 17 illustrates a geofence associated with a plurality of objects created according to another exemplary configuration.

FIG. 18 illustrates a geofence associated with a plurality of objects created according to another exemplary configuration.

FIG. 19 illustrates a geofence associated with a plurality of objects located in an urban setting.

The drawing figures do not limit the present invention to the specific embodiments disclosed and described herein. The drawings are not necessarily to scale, emphasis instead being placed upon clearly illustrating the principles of the invention.

### DESCRIPTION

The following detailed description of embodiments of the invention references the accompanying drawings. The embodiments are intended to describe aspects of the invention in sufficient detail to enable those skilled in the art to practice the invention. Other embodiments can be utilized and changes can be made without departing from the scope of the claims. The following description is, therefore, not to be taken in a limiting sense.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

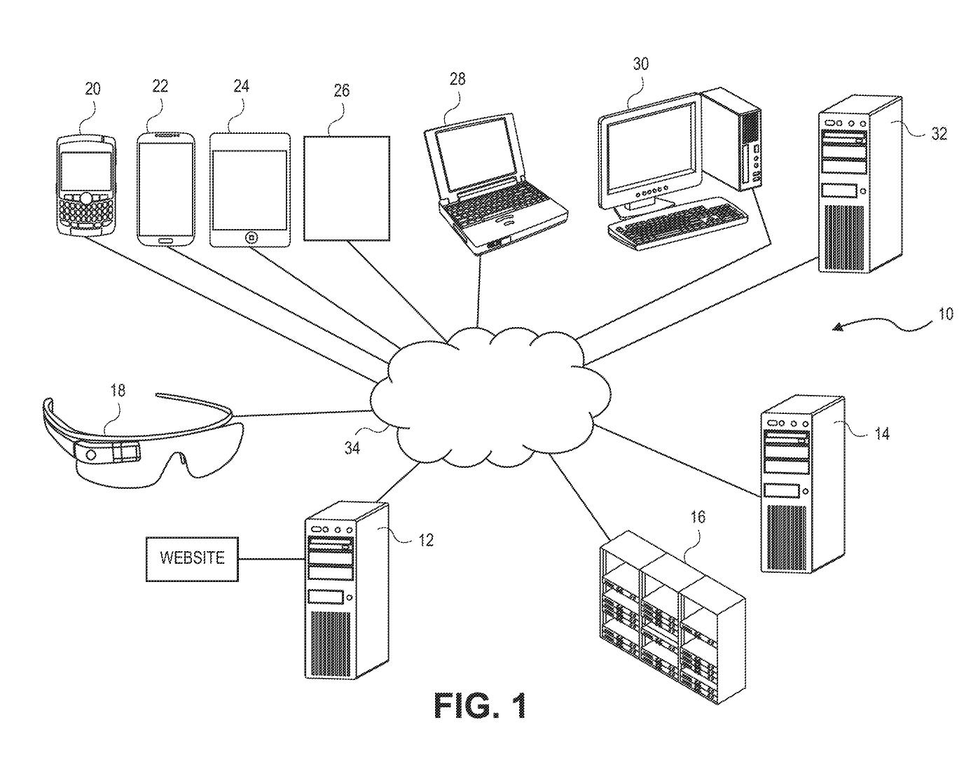

Certain aspects of the present invention can be implemented by, or with the assistance of, computing equipment such as computers and associated devices including data storage devices. Such aspects of the invention may be implemented in hardware, software, firmware, or a combination thereof. In one exemplary embodiment, aspects of the invention are implemented with a computer program or programs that operate computer and communications equipment broadly referred to by the reference numeral 10 in FIG. 1. The exemplary computer and communications equipment 10 may include one or more host computers or systems 12, 14, 16 (hereinafter referred to simply as “host computers”) and a plurality of electronic or computing devices 18, 20, 22, 24, 26, 28, 30, 32 that each may access the host computers or other electronic or computing devices via a communications network 34. The computer programs and equipment illustrated and described herein are merely examples of programs and equipment that may be used to implement aspects of the invention and may be replaced with other programs and computer equipment without departing from the scope of the invention.

The host computers 12-16 and/or the computing devices 18-32 may serve as repositories for data and programs used to implement certain aspects of the present invention as described in more detail below. The host computers 12, 14, 16 may be any computing and/or data storage devices such as network or server computers and may be connected to a firewall to prevent tampering with information stored on or accessible by the computers.

One of the host computers, such as host computer 12, may be a device that operates or hosts a website accessible by at least some of the devices 18-32. The host computer 12 may include conventional web hosting operating software and an Internet connection, and is assigned a URL and corresponding domain name so that the website hosted thereon can be accessed via the Internet in a conventional manner.

One or more of the host computers 12, 14, 16 may host and support a database for storing, for example, cartographic information.

Although three host computers 12, 14, 16 are described and illustrated herein, embodiments of the invention may use any combination of host computers and/or other computers or equipment. For example, the computer-implemented features and services described herein may be divided between the host computers 12, 14, 16 or may all be implemented with only one of the host computers. Furthermore, the functionality of the host computers 12, 14, 16 may be distributed amongst many different computers in a cloud computing environment.

The electronic devices 18-32 may include various types of devices that can access the host computers 12, 14, 16 and/or communicate with each other via the communications network 34. By way of example, the electronic devices 18-32 may include one or more laptop, personal or network computers 28-32 as well as one or more smart phones, tablet computing devices or other handheld, wearable and/or personal computing devices 18-24. The devices 18-32 may include one or more devices or systems 26 embedded in or otherwise associated with a machine wherein the device or system 26 enables the machine, an operator of the machine, or both to access one or more of the host computers 12, 14, 16 and/or communicate with one or more of the computing devices 18-24, 28-32. Each of the electronic devices 18-32 may include or be able to access a web browser and may include a conventional Internet connection such as a wired or wireless data connection.

The communications network 34 preferably is or includes the Internet but may also include other communications networks such as a local area network, a wide area network, a wireless network, or an intranet. The communications network 34 may also be a combination of several networks. For example, the computing devices 18-32 may wirelessly communicate with a computer or hub in a place of business via a local area network (e.g., a Wi-Fi network), which in turn communicates with one or more of the host computers 12, 14, 16 via the Internet or other communication network.

One or more computer programs implementing certain aspects of the present invention may be stored in or on computer-readable media residing on or accessible by the computing and communications equipment 10. The one or more computer programs may comprise ordered listings of executable instructions for implementing logical functions in the host computers 12, 14, 16 and/or the devices 18-32. The one or more computer programs can be embodied in any computer-readable medium for use by or in connection with an instruction execution system, apparatus, or device, such as a computer-based system, processor-containing system, or other system that can fetch the instructions from the instruction execution system, apparatus, or device, and execute the instructions. As used herein, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electromagnetic, infrared, or semi-conductor system, apparatus, device, or propagation medium. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

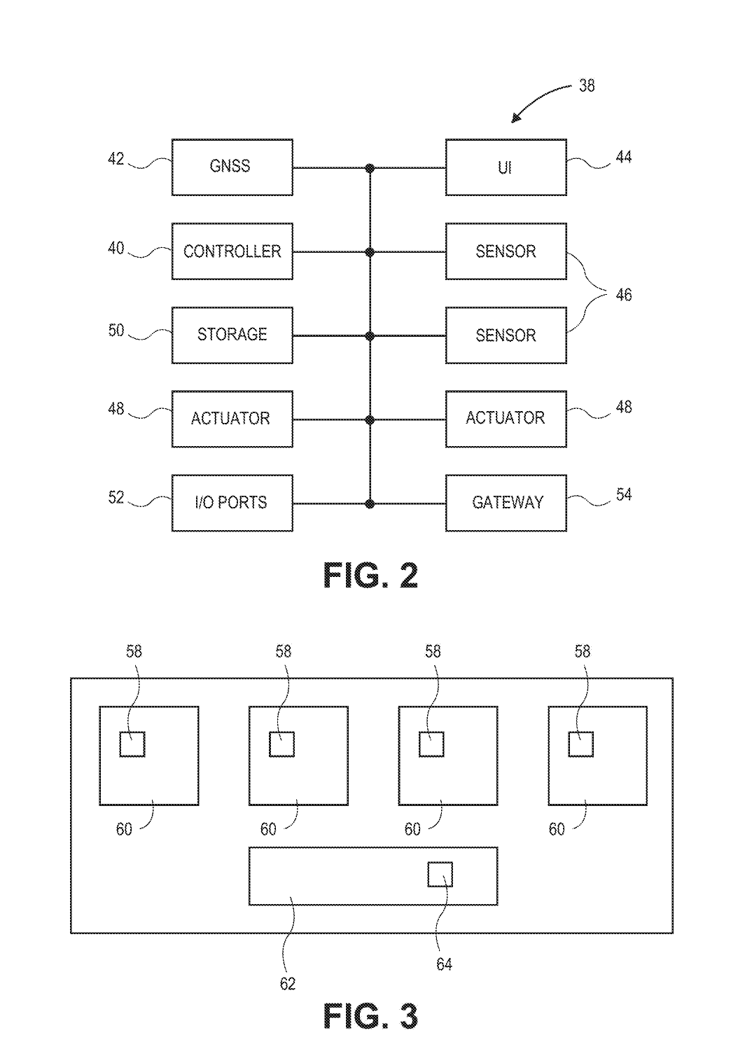

Certain aspects of the present invention can be implemented by or with the assistance of an electronic system associated with a mobile machine. More specifically, aspects of the present invention may be implemented by or with the assistance of an electronic system of a mobile machine used in the agriculture and/or construction industries. Such machines may include tractors, harvesters, applicators, bulldozers, graders or scrapers. Various components of an exemplary electronic system 38 are illustrated in FIG. 2. The system 38 may be or include, for example, an automated guidance system configured to drive the associated machine with little or no operator input. The system 38 broadly includes a controller 40, a position determining device 42, a user interface 44, one or more sensors 46, one or more actuators 48, one or more storage components 50, one or more input/out ports 52 and a gateway 54.

The position determining device 42 may be a global navigation satellite system (GNSS) receiver, such as a device configured to receive signals from one or more positioning systems such as the United States' global positioning system (GPS) and/or the Russian GLONASS system, and to determine a location of the machine using the received signals. The user interface 44 includes components for receiving instructions or other input from a user and may include buttons, switches, dials, and microphones, as well as components for presenting information or data to users, such as displays, light-emitting diodes, audio speakers and so forth. The user interface 44 may include a touchscreen display capable of presenting visual representations of information or data and receiving instructions or input from the user via a single display surface.

The sensors 46 may be associated with any of various components or functions of an associated machine including, for example, various elements of the engine, transmission(s), and hydraulic and electrical systems. The actuators 48 are configured and placed to drive certain functions of the machine including, for example, steering when an automated guidance function is engaged. The actuators 48 may take virtually any form but are generally configured to receive control signals or instructions from the controller 40 (or other component of the system 38) and to generate a mechanical movement or action in response to the control signals or instructions. By way of example, the sensors 46 and actuators 48 may be used in automated steering of a machine wherein the sensors 46 detect a current position or state of steered wheels or tracks and the actuators 48 drive steering action or operation of the wheels or tracks.

The controller 40 includes one or more integrated circuits programmed or configured to implement the functions described herein. By way of example the controller 40 may be a digital controller and may include one or more general purpose microprocessors or microcontrollers, programmable logic devices, or application specific integrated circuits. The controller 40 may include multiple computing components placed in various different locations on the machine. The controller 40 may also include one or more discrete and/or analog circuit components operating in conjunction with the one or more integrated circuits or computing components. Furthermore, the controller 40 may include or have access to one or more memory elements operable to store executable instructions, data, or both. The storage device 50 stores data and preferably includes a non-volatile storage medium such as optic, magnetic or solid state technology.

It will be appreciated that, for simplicity, certain elements and components of the system 38 have been omitted from the present discussion and from the drawing of FIG. 2. A power source or power connector is also associated with the system 38, for example, but is conventional in nature and, therefore, is not discussed herein. Furthermore, the various components of the system 38 may be communicatively interconnected via any of various connection or network topologies, all of which are within the ambit of the present invention.

In some embodiments, all of the components of the system 38 are contained on or in a host machine. The present invention is not so limited, however, and in other embodiments one or more of the components of the system 38 may be external to the machine. In another embodiment, for example, some of the components of the system 38 are contained on or in the machine while other components of the system are contained on or in an implement associated with the machine. In that embodiment, the components associated with the machine and the components associated with the implement may communicate via wired or wireless communications according to a local area network such as, for example, a controller area network. The system 38 may be part of a communications and control system conforming to the ISO 11783 (also referred to as “ISOBUS”) standard. In yet another exemplary embodiment, one or more components of the system 38 may be located remotely from the machine and any implements associated with the machine. In that embodiment, the system 38 may include wireless communications components (e.g., the gateway 54) for enabling the machine to communicate with a remote computer, computer network or system.

With reference to FIG. 3, embodiments of the invention comprise one or more location determining devices 58 for determining the locations of a plurality of mobile objects 60 and one or more computing devices 62 for creating and managing a geofence associated with the locations of the mobile objects 60 as indicated by the location determining devices 58. One or more of the location determining devices 58 may include, for example, the location determining device 42 that is part of the system 38 and illustrated in FIG. 2. Alternatively or additionally, the location determining devices 58 may include hand-held or wearable devices associated with a person, animal or other mobile object. The one or more computing devices 62 may include one or more of the controller 40 and the computing devices 12-32. Hereinafter, the one or more computing devices 62 will be referred to simply as the computing device 62, with the understanding that the component 62 may include a single computing device or multiple computing devices.

As used herein, a “geofence” is a virtual boundary corresponding to a geographic area. A geofence may be large, extending many kilometers, or may be small, extending less than one hundred meters. A dynamic cooperative geofence is a single geofence associated with a plurality of objects, wherein the size, shape and/or location of the geofence depends on the locations of all of the objects and is updated to reflect changes in the locations of the objects. The dynamic cooperative geofence may be updated in real time, in near real time, or on a less frequent basis, such as once every ten seconds, once every twenty seconds, once every thirty seconds, once every minute, once every two minutes, once every five minutes, and so forth.

By way of example, a dynamic cooperative geofence may be used to determine when the location of the group of objects corresponds to or approximates the location of another object (for example, a person or a machine), a geographic location of interest (for example, the edge of a field, a property line, the location of utility conduit or cable), or to a geographic feature (for example, a road, lake, stream, hill or incline). A dynamic cooperative geofence may also be used to identify a central location of the mobile objects associated with the geofence to, for example, identify an optimal rendezvous location. These are but a few examples.

While some embodiments of the invention include the one or more location determining devices 58, other embodiments of the invention only include the computing device 62 configured to receive location information from an external source. In the latter embodiments, the source of the location information is beyond the scope of the invention. In yet other embodiments, the invention consists of a computer readable medium 64, such as a data storage device or computer memory device, encoded with a computer program for enabling the computing device 62 to perform the functions set forth herein.

The plurality of objects 60 may include virtually any mobile objects such as, for example, machines, people and/or animals. Mobile machines may include on-road vehicles, off-road vehicles or both. By way of example, mobile machines may include machines used in the agricultural industry such as tractors, combine harvesters, swathers, applicators and trucks, or machines used in the construction industry, including bulldozers, tractors, scrapers, cranes and trucks. The machines may be self-propelled, such as tractors and bulldozers, or may not be self-propelled, such as implements pulled by tractors or bulldozers. The machines may be operated by a person, such as an operator onboard the machine or in remote control of the machine, or may be autonomous. If the objects 60 are mobile machines, each may include a communications and control system such as the system 38 illustrated in FIG. 2.

The mobile objects 60 may be animals, such as livestock. It may be desirable, for example, to monitor a heard of livestock wherein a cooperative dynamic geofence provides a quick and easy-to-use visual indicator of the location of the group of animals and/or is used to generate an alert of an event associated with movement of the animals. The particular objects are not important to the present invention and, in some embodiments of the invention, may include people. Furthermore, the number of objects associated with the geofence is not important and may vary from two to hundreds of objects. The number of objects associated with the geofence may change during operation and after an initial geofence has been created, wherein objects may be added to, or removed from, a group of objects used to create the geofence, as explained below in greater detail.

At least one location determining device 58 is used to determine the locations of the objects 60. The one or more location determining devices 58 may be located on, embedded in, or otherwise associated with the objects 60. By way of example, if the objects 60 are mobile machines, each of the mobile machines may have a communications and control system similar to the system 38 illustrated in FIG. 2 that includes a GNSS receiver for determining the location of the machine.

The particular devices and methods used to determine the locations of the objects 60 are not important and may vary from one embodiment of the invention to another without departing from the spirit or scope of the invention. While GNSS technology is commonly used today, other technologies may be used to determine the locations of one or more of the objects 60 including, for example, triangulation using cellular telephone signals, laser range finding technology, radio detection and ranging (RADAR), sound navigation and ranging (SONAR), and image capture and analysis technology. If the objects 60 are animals or people, the location determining devices may include wearable devices such as wearable GNSS receivers. A person may wear a GNSS receiver on an arm or attached to a belt or other article of clothing, for example, or an animal may wear a GNSS receiver attached to a collar or ear tag.

The computing device 62 is configured to create the cooperative dynamic geofence using location information generated by the one or more location determining devices 58. The computing device 62 may be located on one or more of the objects 60, such as part of the communications and control system 38, for example, or may be located remote from the objects 60, such as one or more of the computing devices 12-24, 28-32 illustrated in FIG. 1, or both. In some embodiments, the computing device 62 is embedded in or carried on one or more of the objects 60 such that no communications with external computing devices is required. In other embodiments, the computing device 62 is accessible via the Internet such that the computing is performed remotely from the objects 60. If the computing is performed via a computer accessible via the Internet, view and control of the geofence may be accessible via the Internet in the form of, for example, a webpage/website or via dedicated software running on a tablet computer, smartphone, personal computer or laptop computer. If the computing device 62 is located exclusively on one or more of the objects 60, the objects 60 may be equipped with communications devices operable to communicate with an external computing device, such as a smartphone, tablet computer, personal computer or laptop computer to communicate geofence information to the external computing device. The external computing device may present a graphical representation of the geofence to a user, receive instructions from the user, or both.

The computing device 62 is broadly configured to identify the location of each of the mobile objects 60, generate a single geofence corresponding to the mobile objects 60, identify changes in the locations of the mobile objects 60 and modify the geofence to reflect the changes in the locations of the mobile objects 60. The computing device 62 may also be configured to detect events associated with the geofence and respond to the events; dynamically include additional objects in the geofence group and remove objects from the geofence group after the geofence is created; and/or use the geofence to identify a location that is central to the objects in the geofence group.

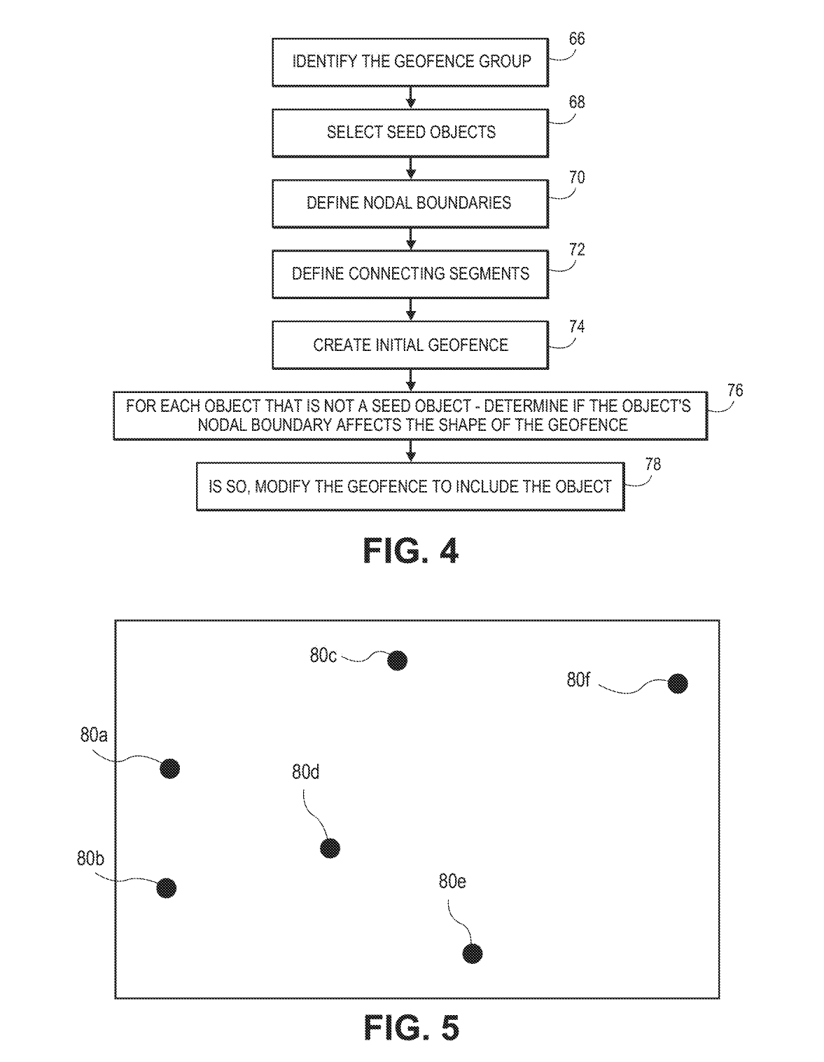

Various steps of an exemplary method of creating a geofence are depicted in FIG. 4. The computing device 62 identifies a geofence group, as depicted in step 66. The geofence group is a group of objects associated with the geofence and used to define the size, shape and location of the geofence. The geofence group may not include all of the objects in a particular region or area. The objects comprising the geofence group may be selected or identified by a user, by the computing device 62, or both. By way of example, the geofence group may be selected randomly or arbitrarily by a user via a user interface, may include objects located within a boundary or region such as a field, pasture or construction zone, or may be objects located within a designated distance of a geographic location or an object, including one of the mobile objects in the geofence group.

A graphical representation of the locations of an exemplary plurality of objects 80 is illustrated in FIG. 5. Some or all of the objects 80 may be included in a geofence group. The computing device 62 may automatically select some or all of the available objects 80 to form part of the geofence group, and this may occur without any intervention by a user. Alternatively, the computing device 62 may present the available objects to a user via a user interface and enable the user to select some or all of the objects 80 for inclusion in the geofence group. FIG. 5 may illustrate, for example, a portion of a display that forms part of the user interface 44 of FIG. 2, wherein a user selects two or more of the objects 80 for the geofence group via the user interface 44. Alternatively, a designated or predetermined boundary may be used to identify the objects included in the geofence group. Such a designated or predetermined boundary may be or include a field that was previously worked by agricultural equipment, a construction zone, or a pasture where livestock are held. The objects in the geofence group may change over time as new objects are added to the group and existing objects are removed from the group, as explained below.

For purposes of illustration it will be assumed that objects 80a-80e were selected or identified for inclusion in the geofence group. Once the geofence group is identified, the computing device 62 begins creating a geofence associated with the group of objects included in the geofence group by selecting seed objects (if necessary), as depicted in step 68 of FIG. 4. Seed objects are used to define an initial geofence and may be selected, for example, according to a method that identifies the objects corresponding to the outermost locations of the geofence group. If the geofence group consists of only four or fewer objects, it may not be necessary to select seed objects, depending on the method of creating the geofence. The geofence group illustrated in FIG. 5 includes five objects—objects 80a through 80e—and the computing device 62 may identify a subset of those objects as seed objects.

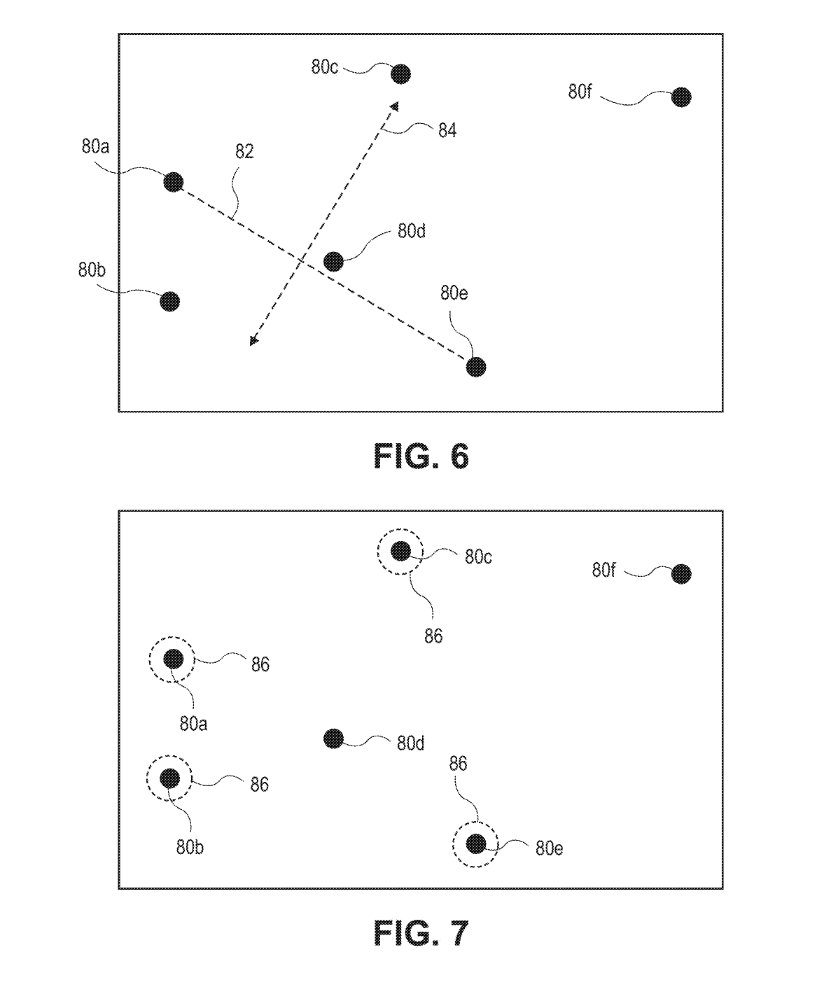

One method of selecting seed objects includes selecting the objects corresponding to outer extreme locations along two axes. A first axis may be defined by two objects from the geofence group separated by the greatest distance, and a second axis may be defined as orthogonal to the first axis, as illustrated in FIG. 6. Using this method, objects 80a and 80e are selected as corresponding to the objects in the group separated by the greatest distance, and a first axis 82 is defined as intersecting the objects 80a and 80e. A second axis 84 is defined as orthogonal to the first axis 82, and objects 80b and 80c are identified as the objects corresponding to outer extreme locations along the second axis 84. Stated differently, the objects 80b and 80c are the two objects separated by the greatest distance along a direction parallel with the second axis 84. Other methods may be used to identify seed objects, including selecting a subset of objects located furthest from a geographic center of the geofence group.

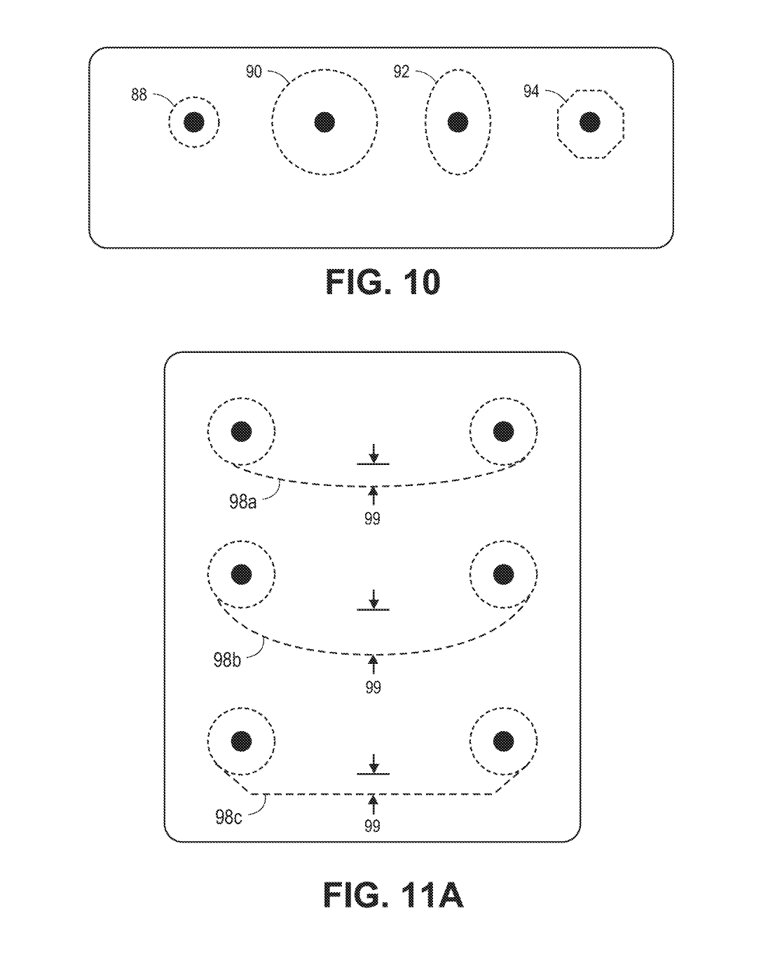

When the seed objects are defined, the computing device 62 defines a nodal boundary 82 for each of the seed objects, as depicted in step 70 of FIG. 4 and as illustrated in FIG. 7. The nodal boundaries may be defined by nodal parameters, which may be preset or designated by a user. While the nodal boundaries 86 illustrated in FIG. 7 are circular and of uniform size, it will be appreciated that the nodal boundaries associated with the objects may be of virtually any size and shape without departing from the spirit or scope of the invention, and may vary from one object to another. A few exemplary variations of the nodal boundaries are illustrated in FIG. 10, including a smaller round boundary 88, a larger round boundary 90, and nodal boundaries presenting elliptical 92 and polygonal 94 shapes. These are but a few examples. Other nodal boundary shapes, including arbitrary shapes, are within the ambit of the invention.

The nodal boundaries 86 may include separation information and shape information. The separation information may include, for example, a radius corresponding to a distance from a center of the object's location. If the nodal boundary is circular, the radius may define the boundary. If the nodal boundary is not circular, the radius may define a minimum distance from a center of the object's location, a distance to points on a polygon, etcetera. Information other than a radius may be used to define the nodal boundaries, including values defining an ellipse. The shape information may define the nodal boundary as circular, elliptical, polygonal or virtually any other shape. The nodal parameters may be common to all of the objects or may vary from one object to another.

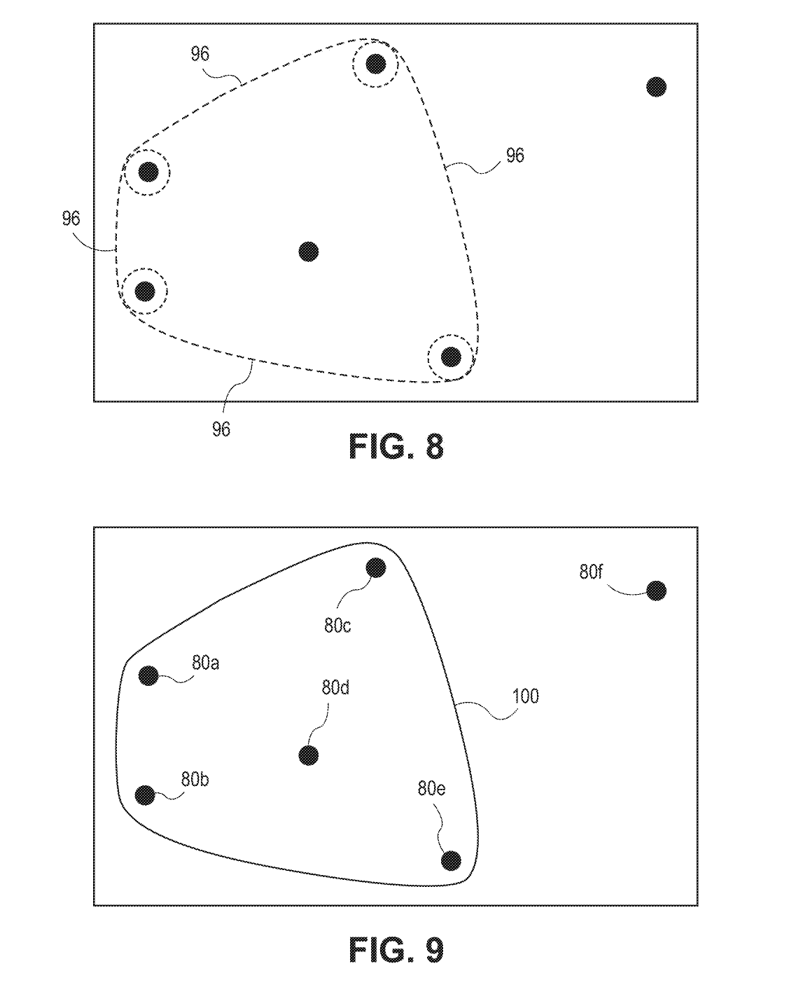

After creating the nodal boundaries for the seed objects, the computing device 62 defines connecting segments 96 between the nodal regions of the objects 80 using segment parameters, as depicted in step 72 of FIG. 4 and as illustrated in FIG. 8. The segment parameters may include shape information, deviation information and placement information. The shape information defines the general shape of the segment which may be, for example, linear, curved (for example, circular or elliptical) or polygonal. In the example illustrated in FIG. 8, the segments present a curved shape.

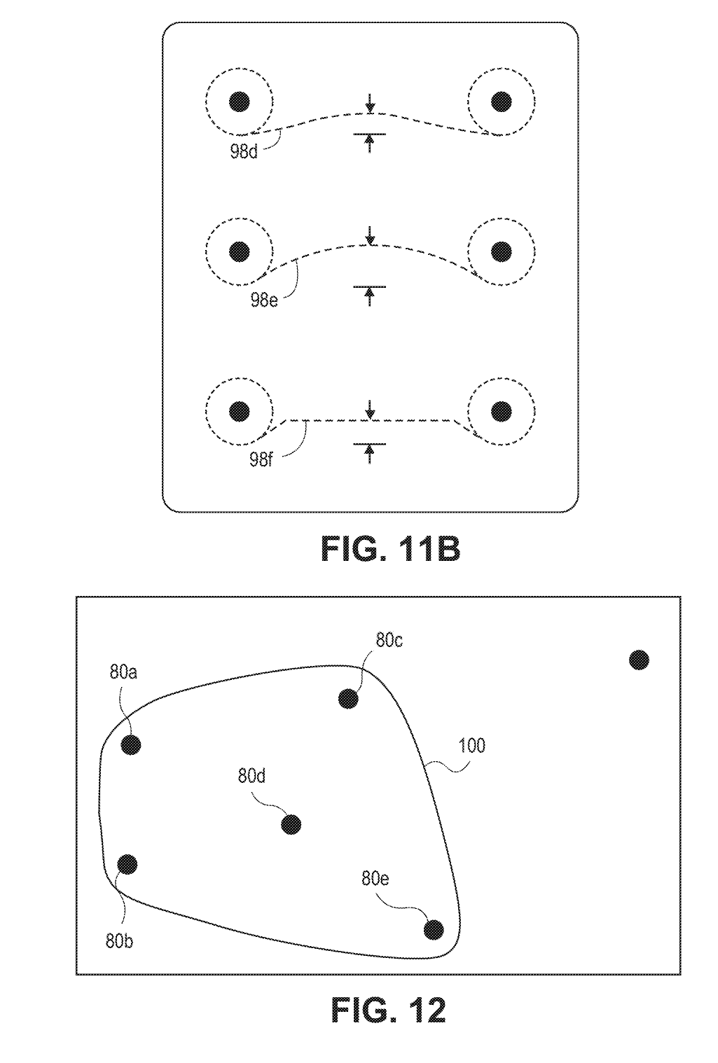

The deviation information may include information about the extent to which the segment deviates from a straight line connecting the nodal boundaries 86. The deviation information may include one or more variables or expressions defining the radius of a circle, the shape of an ellipse or the shape of a polygonal segment. The deviation information may also include an indication of whether the segment deviates outwardly (FIGS. 8, 11A) or inwardly (FIG. 11B) relative to a center of the geofence. A positive deviation value may correspond to an outward deviation, for example, while a negative deviation may correspond to an inward deviation. The placement information may include where each segment is placed relative to the nodal region of each object. In the example illustrated in FIG. 8, the segments are placed to correspond to outer portions of the boundaries 86 such that the segments are tangential to the nodal boundaries. Other configurations may be used as well, as explained below.

FIGS. 11A and 11B illustrate a few exemplary variations of the shape and deviation of the connecting segments. Segment 98a presents an elliptical shape with a positive deviation and segment 98d presents an elliptical shape with a negative deviation. Both segments 98a and 98d have approximately the same deviation amount corresponding to a distance indicated by reference numeral 99. Segment 98b presents a circular shape with a positive deviation and segment 98e presents a circular shape with a negative deviation. Both segments 98b and 98e have approximately the same deviation amount, which is approximately twice the deviation amount of segments 98a and 98d. Segment 98c presents a polygonal shape with a positive deviation segment 98f presents a polygonal shape with a negative deviation. Some exemplary variations in the connecting segments' placement are illustrated in FIGS. 17 and 18. In FIG. 17, for example, the segments are straight and are placed to intersect a center of each of the objects. No nodal boundaries need to be used for this implementation. In FIG. 18, the segments are straight and are placed to intersect the nodal boundaries on a side toward the inside of the geofence (closest a geographic or geometric center of the geofence).

After the initial geofence 100 is created, the computing device 62 determines whether the objects 80 that were not seed objects affect the size, shape or location of the geofence, as depicted in steps 76 and 78 of FIG. 4. This process may involve defining a nodal boundary around each of the objects and determining whether the nodal boundary intersects the initial geofence 100. If so, the computing device 62 adjusts the geofence 100 to include the object. If not, the geofence 100 is left unchanged. The object 80d in FIG. 9, for example, is inside the geofence 100 and, if it has the same nodal parameters as the other objects, will not affect the size or shape of the geofence 100. This process (that is, steps 76 and 78 of FIG. 4) is performed for each of the objects not used as seed objects. When all of the objects have been considered and the geofence adjusted accordingly, the geofence is complete.

As the objects in the geofence group move, the computing device 62 will adjust the size, shape and location of the geofence 100 to reflect the new locations of the objects. The computing device 62 may do this by completely recreating the geofence 100 as described above each time a new location is detected, or by changing only those portions of the geofence 100 that correspond to the object whose location changed.

The nodal parameters and the segment parameters may be predetermined and static, such as where the parameters are built into hardware or software components, or may be dynamic and/or adjustable by a user, such as where the computing device 62 presents the nodal parameters to a user via a user interface (such as the user interface 44) and the user can manipulate the parameters. The computing device 62 may enable a user to indicate the nodal parameters for each of the nodes and the segment parameters for each of the segments separately. The parameters are “indicated by a user” if the user can set or adjust the parameters, either prior to or during operation, using a touchscreen, knob, button or other input mechanism or method.

As illustrated and described above, the computing device 62 creates a single geofence associated with all of the objects 80 in the geofence group. It will be appreciated that this is different than creating a separate geofence for each of the objects. In some embodiments, the single geofence 100 is a continuous geofence surrounding all of the objects, as illustrated in FIG. 9. Movement of any one of the objects may change the shape of the single geofence 100, and the total area defined by the geofence changes as the objects move toward and away from one another. FIG. 12, for example, illustrates the geofence 100 after it has been modified relative to the geofence of FIG. 9 to reflect movement of the object 80c. The computing device 62 may receive updated location information from the one or more location determining devices 58 in real time or in near real time, or may receive the updated location information less frequently. The computing device 62 may update the shape of the geofence to reflect changes in the locations of the objects as frequently as updated location information is received, including in real time or in near real time. As used herein, updates are made in “real time” if there is no perceptible delay from the point of view of a user.

The computing device 62 may be configured to automatically add new objects to the geofence group, automatically remove objects from the geofence group, or both. The computing device 62 may be configured to automatically add and/or remove objects from the geofence group according to inclusion rules. An object may be added to the group if, for example, it intersects the geofence, is within a designated distance from the geofence, is within a designated distance of any one of the objects currently in the geofence group, is within a designated distance of each of at least two (or other number) of the objects currently in the geofence group, is within a designated distance of a center of the geofence, and so forth. Similarly, the computing device 62 may automatically remove an object from the group if the object is separated from a nearest other geofence object by a designated minimum distance, if the object is separated from a center of the geofence by a designated minimum distance, and so forth.

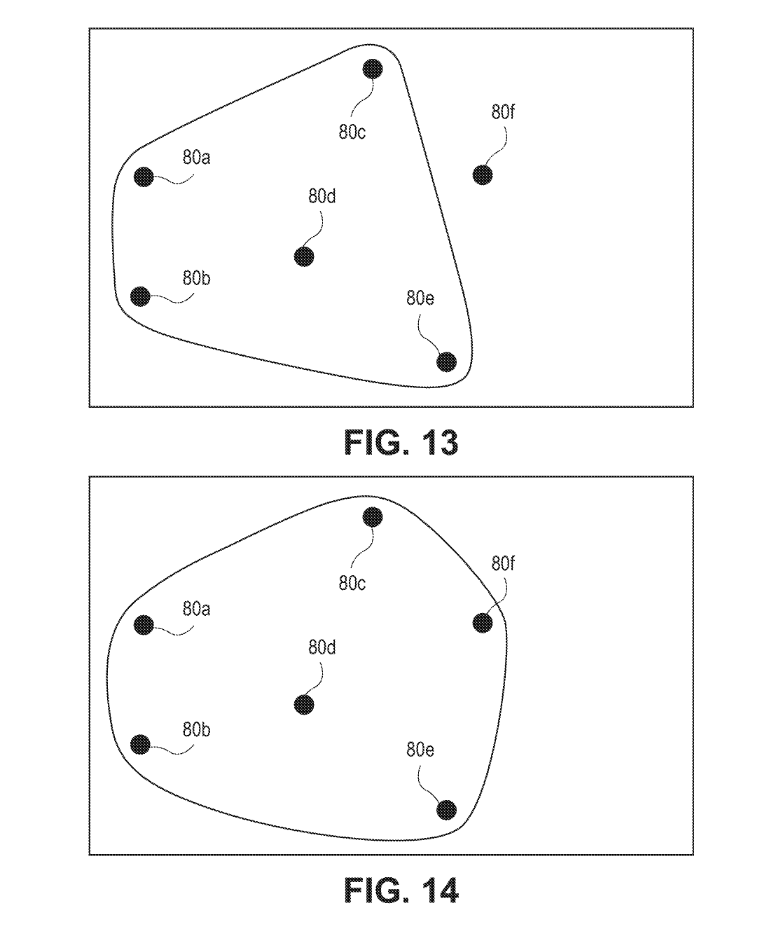

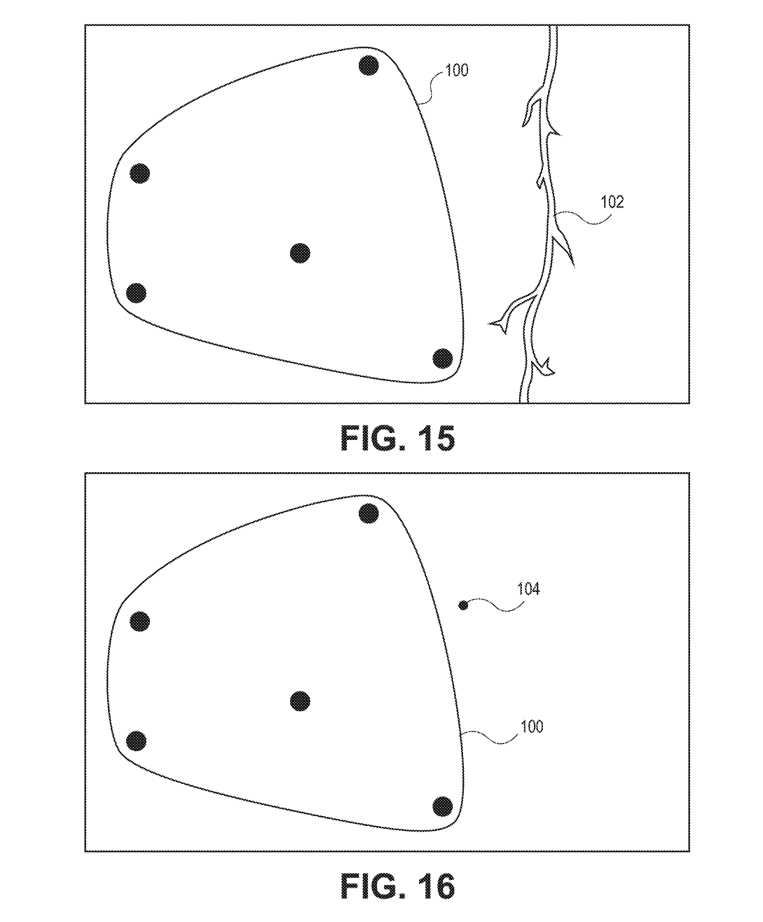

An example is illustrated in FIGS. 13 and 14. The object 80f, which was initially not part of the geofence group (FIG. 9), moves to a location that is closer to the geofence 100. If the new location of the object 80f qualifies it to be a part of the geofence group according to the inclusion rules, the computing device 62 adds the object 80f to the geofence group and modifies the geofence 100 to reflect the presence of the object 80f, as illustrated in FIG. 14. If the object 80f moves back to a location similar to where it was in FIG. 9, the computing device 62 may remove the object 80f from the geofence group.

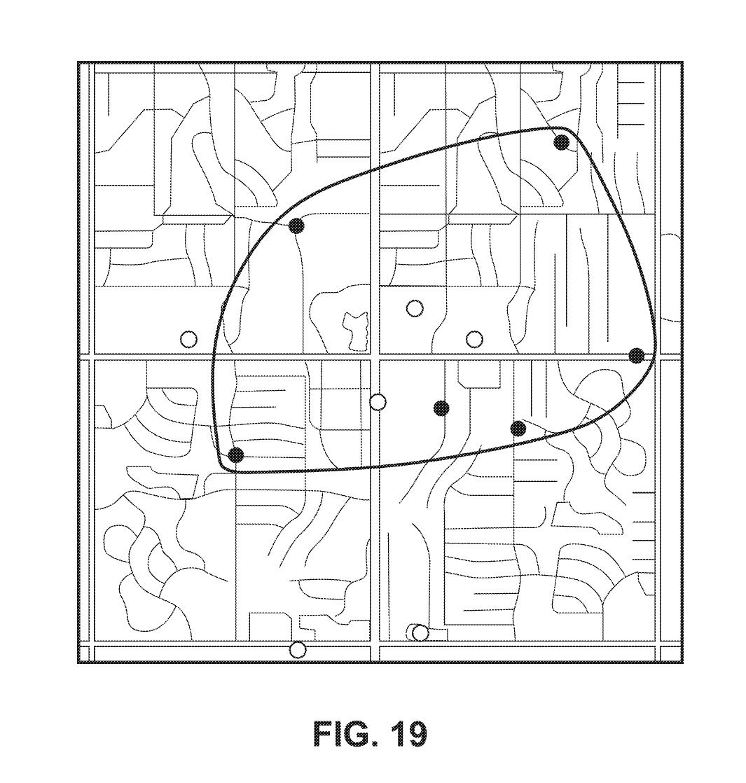

The computing device 62 may present a graphical representation of the geofence 100 to one or more users, and may update the graphical representation in real time or near real time. The graphical representation may include a representation of a geographic area proximate the geofence, including geographic features (see, for example, FIG. 15), cartographic features (see, for example, FIG. 19), and the locations of other objects whose locations are being tracked. An exemplary display illustrating a geofence corresponding to a plurality of objects in an urban setting and presenting cartographic features including roads, parks and bodies of water is illustrated in FIG. 19.

If the objects are vehicles, the computing device 62 may present the geofence as a graphical representation on a display in one or more of the vehicles. The computing device 62 may also present a graphical representation of the geofence on one or more devices such as the devices 20-24, 28, 30 illustrated in FIG. 1. The geofence may be presented on a device at a location remote from the geofence, such as an office.

The computing device 62 may enable a user to modify the geofence after the geofence is created and at any time during operation. The user may modify the geofence graphically by, for example, touching a portion of the geofence on a touchscreen and dragging it to change one or more of the parameters used to define the geofence. Alternatively, the user may modify the geofence by submitting or selecting numeric values by adjusting knobs, buttons or the like to adjust parameters defining the geofence.

The computing device 62 may be configured to detect an event associated with the geofence and to respond to the event. The event may be associated with the proximity of the geofence to a location, landmark, geographic feature, a mobile object, etcetera. In a first example, the event is the proximity of the geofence to a geographic feature or geographic location. A group of agricultural machines or construction machines may be operating in the same region as a stream 102 or body of water, as illustrated in FIG. 15. If any portion of the geofence 100 intersects any portion of the stream 102, or is within a designated distance of any portion of the stream 102, the computing device 62 may treat that as an event and respond by generating an alert message communicated to a user, by generating machine instructions communicated to a machine, or both. Rather than a stream or body of water, the computing device 62 may be configured to detect proximity to a field boundary, a road or highway, an underground object or geographic feature such as a pipeline, and so forth.

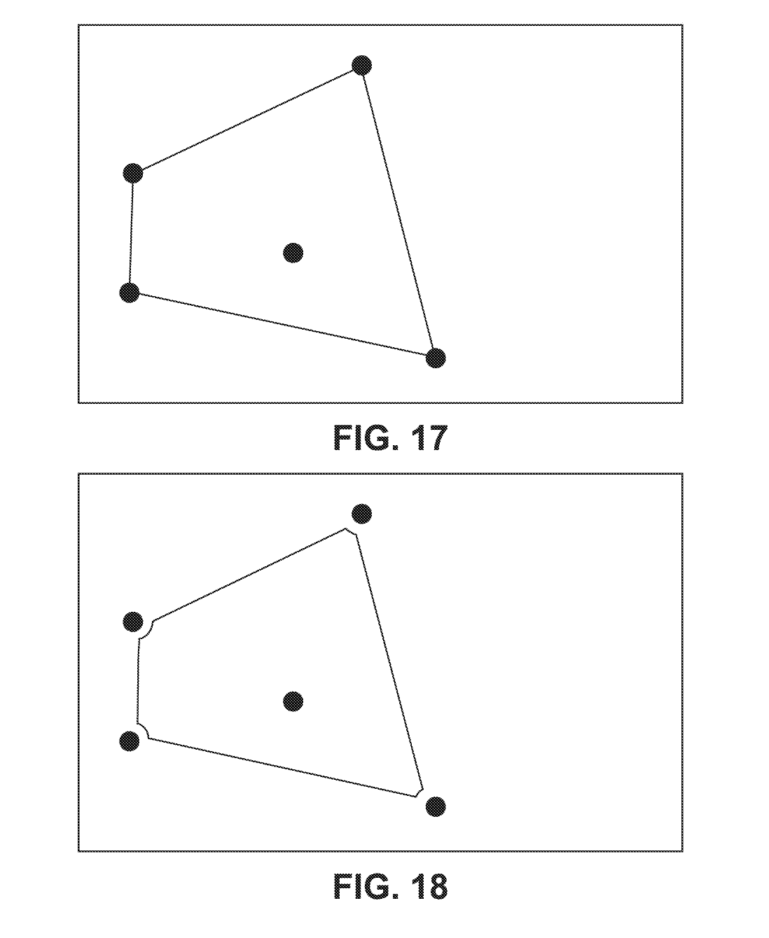

In another example, the event is the proximity of the geofence 100 to a foreign mobile object 104, as illustrated in FIG. 16. The object 104 may be a person equipped with a location determining device whose location is tracked by the computing device 62. If the geofence group is a group of agricultural or construction machines it may be necessary to detect the person's presence and generate an alert to machine operators to protect the person's safety. The computing device 62 may generate an alert if the person intersects any portion of the geofence or comes within a designated distance of the geofence. In this example, the proximity of the object 104 to the geofence 100 may be affected by movement of the object 104, by movement of the geofence 100, or both.

In another example, the event is associated with one or more characteristics of the geofence itself. A total area enclosed by the geofence is indicative of separation of the objects. A large area may represent more separation while a smaller area may represent less separation. A total area of the geofence that exceeds a designated maximum or is less than a designated minimum may constitute an event to which the computing device responds. Similarly, too much or too little movement of the geofence may be indicative of too much or too little activity of the group of geofence objects and may constitute an event to which the computing device responds.

The computing device 62 may respond to the events in a number of ways, including communicating messages to one or more users and communicating machine instructions to one or more machines. The computing device 62 may communicate messages to users by communicating messages to one or more of the objects 80, such as where the object is a machine with a user interface and the computing device communicates the message for display on the user interface, or may communicate messages to users by communicating messages to one or more handheld, tablet, laptop or desktop computing devices such as one of the devices 20-24, 28-32 illustrated in FIG. 1. Communicating messages to one or more of the objects may alert an operator to a risk or hazard and enable the operator to mitigate the risk or hazard.

Messages communicated to users may take several forms. A graphical depiction of a geofence may flash or change colors, for example, or a textual message may be presented to a user. The messages may be communicated via any communications means including proprietary/private communication standards or protocols or commercial standards or protocols including SMS, MMS, email and the like.

The computing device 62 may also respond to the events by communicating machine instructions to one or more machines. If the group of geofence objects is a group of agricultural or construction machines, for example, it may be necessary to communicate machine instructions to one or more of the machines in the geofence group in response to an event. If the presence of a person is detected within or near the geofence, it may be necessary to disable operations of one or more of the machines in the geofence group for the person's safety. It will be appreciated that machine instructions communicated to a machine are not intended to be presented to a user. Rather, machine instructions are communicated to a machine for the purpose of, for example, slowing, stopping or delaying one or more operations of the machine.

The computing device 62 may be configured to respond to events associated with the geofence through a series of tiered responses. The tiered responses may be progressively more aggressive and/or progressively more targeted, as, for example, time elapses or as the geofence draws closer to an object or to a geographic feature. Progressively more aggressive responses may progressively include additional users or machines or may progressively increase in intensity or severity. By way of example, a first response may include an alert communicated to a user and a second response may include machine instructions communicated to a machine. According to another example, a first response may include a first alert communicated to a first group of users, a second response may include a second alert communicated to a second group of users (which may include the first group of users plus additional users), a third response may include machine instructions for partially shutting down operations of a machine, and a fourth response may include machine instructions for completely shutting down a machine.

The computing device 62 may be configured to enable one or more functions associated with objects in the geofence group. By way of example, if the objects are machines used in the construction or agriculture industries, it may be desirable to include certain of the objects in a communications network, such as a mesh network. The computing device may generate the geofence and add and remove machines from the geofence group according to inclusion rules as explained above, and also include machines in the group in the communications network. As the computing device 62 adds machines to the geofence group it also adds them to the communications network, and as the computing device removes machines from the geofence group it also removes them from the communications network.

The computing device 62 may be configured to identify a geographic location that corresponds to a center of the geofence 100. This function may be useful, for example, to determine an optimal meeting location of the objects to minimize travel time to the meeting location. The center of the geofence may correspond to a geometric center of the shape formed by the geofence, or may simply be the intersection of two lines—one representing the midpoint between extreme north and south points of the geofence and the other representing the midpoint between extreme east and west points of the geofence.

If the objects are vehicles travelling on roads (for example, FIG. 19), it may be desirable to identify a central rendezvous point for the vehicles. Because the vehicles are limited to travelling on roads, the computing device may be configured to identify a geographic location accessible by road (for example, a point on a road or a location of a business) that is nearest a center of the geofence. Furthermore, a user may suggest a plurality of locations wherein the computing device selects one of the suggested locations nearest a center of the geofence. This may be useful, for example, where a user desires to suggest a plurality of restaurants and let the computing device determine which of the suggested restaurants is nearest a center of the geofence.

It will be appreciated that the geofence may be used for any combination of the purposes explained herein. The geofence may be used to detect proximity of the group of objects to a geographic feature, for example, and to manage a communications network.

Although the invention has been described with reference to the preferred embodiment illustrated in the attached drawing figures, it is noted that equivalents may be employed and substitutions made herein without departing from the scope of the invention as recited in the claims. The exemplary implementations and scenarios discussed herein, for example, generally relate to the construction and agriculture industries. The invention is not so limited, however, and may find use in virtually any industry or setting including sports, military, delivery services, public or private transportation and so forth.

Having thus described the preferred embodiment of the invention, what is claimed as new and desired to be protected by Letters Patent includes the following:

1. A system comprising:
one or more location determining devices for determining the geographic locations of a plurality of mobile objects; and
one or more computing devices operable to
using data generated by the one or more location determining devices, identify the geographic locations of the objects,
generate a single geofence corresponding to the geographic locations of the plurality of mobile objects,
identify a change in the geographic location of at least one of the objects,
change the geofence to reflect the change in the geographic location of the at least one object,
detect an event associated with the geofence, and
respond to the event.

2. The system as set forth in claim 1, wherein the objects associated with the geofence form a geofence group, and wherein the one or more computing devices are operable to
after generating the geofence, include an additional object in the geofence group according to inclusion rules, and
after generating the geofence, remove an object from the geofence group according to the inclusion rules.

3. The system as set forth in claim 1, the one or more computing devices operable to generate the geofence such that the geofence surrounds the plurality of mobile objects and is defined in a nodal region of each object according to nodal parameters associated with each object.

4. The system as set forth in claim 3, the one or more computing devices further operable to
present a user interface to a user,
receive nodal parameters from a user via the user interface, and
generate the geofence using the nodal parameters.

5. The system as set forth in claim 4, the one or more computing devices operable to generate the geofence such that the geofence is defined between the nodal regions according to segment parameters.

6. The system as set forth in claim 5, the one or more computing devices further operable to
present a user interface to a user,
receive segment parameters from a user via the user interface, and
generate the geofence using the segment parameters.

7. The system as set forth in claim 1, the one or more computing devices further operable to detect an event associated with the geofence by detecting when the geofence intersects or approximates a geographic feature or geographic location.

8. The system as set forth in claim 1, the one or more computing devices further operable to respond to the event by communicating a message to a user.

9. The system as set forth in claim 1, the one or more computing devices further operable to respond to the event by communicating machine instructions to a machine.

10. The system as set forth in claim 1, the mobile objects being mobile machines and the one or more location determining devices being GNSS receivers positioned on the machines.

11. The system as set forth in claim 1, the mobile objects being animals and the one or more location determining devices being GNSS receivers positioned on the animals.

12. The system as set forth in claim 1, wherein changing the geofence to reflect the change in the geographic location of the at least one object involves changing the size and shape of the geofence.
